(19) United States
(12) Patent Application Publication
(10) Pub. No.: US 2008/0235094 A1
(43) Pub. Date: Sep. 25, 2008

(54) INTEGRATED CROSS CORPORATE BRANDING WITH GIVEAWAYS AND SWEEPSTAKES AND CONTESTS PROCESSES WITH ADVERTISING OPPORTUNITIES ON A HAND WIPE PRODUCT

(76) Inventors: Doug K. Jones, Wilton, CT (US); Joseph J. Spiroso, Tampa, FL (US)

Correspondence Address: Douglas Jones, 644 Danbury Road, Wilton, CT, 06897, US

(21) Appl. No.: 12/054,232

(22) Filed: Mar. 24, 2008

Related U.S. Application Data
(60) Provisional application No. 60/896,540, filed on Mar. 23, 2007.
(60) Provisional application No. 60/945,945, filed on Jun. 24, 2007.

(51) Int. Cl. G06Q 30/00

(52) U.S. Cl. 705/14

(57) ABSTRACT

The present invention provides systems, methods, and apparatus for integrated cross corporate branding using a hand wipe product. The invention includes advertising by producing a plurality of high quality, individually packaged, disposable hand wipes packaged in a wrapper, the wrapper including an indicia of a third-party and an indication of an online source for additional hand wipes, wherein the high quality of the hand wipes is such that the third party perceives that an association of the third party with the hand wipes reflects positively on the third party; distributing the plurality of hand wipes to target customers of the third party without charge to the target customers; and selling additional hand wipes to the target customers via the online source. Numerous additional aspects are disclosed.

### CROSS-REFERENCE TO RELATED APPLICATIONS

The present application claims priority to U.S. Provisional Application No. 60/896,540 filed Mar. 23, 2007 and entitled “Integrated Cross Corporate Branding with Giveaways, Sweepstakes and Contests Processes with Advertising Opportunities Hand Wipe Products” which is hereby incorporated herein by reference in its entirety for all purposes.

The present application also claims priority to U.S. Provisional Application No. 60/945,945 filed Jun. 24, 2007 and entitled “Individually-Packaged Antimicrobial and Antibacterial Moist Towelette for Hand and Skin Sanitization” which is also hereby incorporated herein by reference in its entirety for all purposes.

### FIELD OF THE INVENTION

The present invention relates to integrated cross corporate branding using giveaways, sweepstakes, and contests, and more particularly to integrated cross corporate branding using a hand wipe product.

### BACKGROUND

Cleanliness is a crucial aspect of personal health. While improved sanitation systems, immunization programs, and the development of antibiotic drugs during the 1900's in the United States and the rest of the developed world have overcome serious infectious diseases like diphtheria and pneumonia that previously killed large numbers of people, the presence of bacteria, viruses, and other germs still cause diseases in people that produce discomfort and lost productivity, and require medical treatment. For example, over 22 million school days and many more work days are lost in the U.S. each year due to people suffering from illness. Each year, approximately 52.2 million cases of the common cold virus, alone, affect Americans.

The cold virus can be spread between people by hand-to-hand contact, or picked up from surfaces on which the virus exists. The Rota virus germ that causes gastrointestinal illness can be transferred from a dry smooth surface to a clean hand for as long as 20 minutes after the surface has been contaminated. Acute Respiratory Syndrome (“SARS”), hepatitis A, meningitis, and infectious diarrhea are other common prevalent health problems. Meanwhile, food-borne illnesses based upon E. coli, Salmonella, and other bacteria can be spread to others by microorganisms that can live on surfaces like cafeteria tables and doorknobs for up to two hours. And, of course, influenza and pneumonia have not been completely eradicated by public health systems. These two diseases in combination are the seventh leading causes of death among Americans.

Unfortunately, many people fail to wash their hands in public places, thereby exposing themselves to the germs that cause these illnesses by rubbing their noses or eyes after touching someone or something contaminated with the bacteria or virus. Moreover, such people can transfer this risk of infection to others since most such bacteria and viruses can be transferred by hand-to-hand contact. In one study, only 58% of female and 48% of male middle and high school students washed their hands after using the restroom, and of the individuals who did wash their hands, only 33% of the females and 8% of the males actually used soap. In another study of 341 children's daycare centers, infrequent hand washing of the children or providers after nose wiping, diaper changes, and before meals correlated to higher frequencies of illness. Conversely, another study involving Detroit school children in which scheduled hand washing at least four times each day showed a reduction in gastrointestinal illness and related absences by more than 50%.

Despite the proven health benefits of good hand hygiene, many people simply do not bother to wash their hands or do so incorrectly. The bathrooms in restaurants can suffer from long lines, thereby discouraging people from taking the time to wash their hands before eating. Moreover, many food courts at malls have eliminated their restroom facilities in order to save the need to clean them. In such situations, people have nowhere to go to wash their hands. However, even in cases where people do stop to wash their hands before eating, there may be a failure to wet the hands, followed by thorough lathering of the hands with soap, so that the surfactants contained in the soap can attach themselves to the germs and dirt particles to suspend them within the hot or warm rinse water that is necessary to eliminate the harmful germs and dirt from the hands.

This need for concerted and thorough hand washing extends beyond mealtimes. Other important occasions during a person's day in which infectious germs or viruses may be prevalent include after using the restroom, after changing diapers, before and after the preparation of foods, before and after treating wounds or cuts, before and after touching a sick or injured person, after blowing one's nose, after touching animals or animal waste, after handling garbage, and after handling money.

Pre-moistened and disposable towelettes impregnated with a cleaning and/or disinfectant solution have become increasingly popular in the marketplace. Often called “wet wipes” or “wipes,” they provide a convenient method of applying disinfectant to a kitchen counter (Clorox's “Disinfecting Wipes”), cleaning agent to a toilet bowl (S.C. Johnson's “Scrubbing Bubbles Flushable Toilet Wipes”), cleaner and disinfectant to a baby's bottom (Pampers Wipes), or cleaner to a floor (Swiffer Wet Cleaning System). These companies emphasize not only the convenience provided by such products (i.e., no need to maintain household stocks of sponges and rags in addition to the branded cleaning agent—the wipe can be simply thrown in the garbage after its use), but also the fact that they kill germs instead of spreading them around. Hand sanitizers have also become popular with people who are very concerned about killing germs that their hands pick up. Such alcohol-based gels come in a bottle that can be carried in a purse or pocket. They include a germicide and evaporate quickly after application to the hands, thereby saving the need for a towel to dry the hands.

Paper towels are typically available in dispensers located in public bathrooms near the sink. For those people who take the time and trouble to clean their hands with soap and water, the towels can be used to dry their hands with a trash receptacle close by for disposal of the used paper towel. U.S. Pat. No. 1,688,242 issued to Lawrence et al.; U.S. Pat. No. 2,415,588 issued to Gui; U.S. Pat. No. 1,994,394 issued to Horwitt; and U.S. Pat. No. 1,681,840 issued to Carlson disclose typical paper towel and waste basket arrangements. U.S. Pat. No. 4,788,909 issued to Stewart improves upon this simple concept by providing a wall-mounted paper towel dispenser and wastebasket whereby the person needs to step on a pedal to advance the next paper towel, which also activates a tamper in the wastebasket that compacts the volume of used towels to reduce the incidence of overflowing wastebaskets. U.S. Pat. No. 4,173,792 issued to Rex shows a windshield washer station for use at a gas station that includes a paper towel dispenser and wastebasket in addition to the receptacle container, the windshield cleaning solution and squeegee.

Most restrooms rely upon simple soap and water for hand washing with the accompanying need for the proper hand washing technique discussed above. Moreover, most people do not carry hand wipes or hand sanitizer products with them, and therefore have no ready means for cleaning their hands, even if they wanted to do so, unless a restroom is reasonably accessible. Therefore, efforts have been made within the industry to increase the portability or availability of such hygiene products. U.S. Pat. No. 3,072,245 issued to Faltin in 1963, for example, provided an early example of a hand carried litter container with a box on one side for dispensing paper tissues, and a box with a lid on the other side of disposal of the used paper tissues. U.S. Pat. No. 5,687,875 issued to Watts et al. discloses a more recent idea for a portable dispenser for paper wipes with a slot on the backside for disposal of the wipes after use.

U.S. Pat. No. 4,644,689 issued to Arians addresses concerns over germs that might breed on the door knobs of public bathrooms. Therefore, it discloses an arrangement consisting of a paper towel dispenser located immediately above the door handle and a trash receptacle positioned immediately below the door handle. In this manner, the person who wishes to exit the bathroom can grab a paper towel and use it to grab the door handle to open the door, letting the towel drop in the trash receptacle when he releases the towel as he walks through the open door. Of course, such a towel dispenser does nothing for cleaning the hands or killing the germs on the door handle.

Similar efforts have been made to provide dispensers for wet wipes that clean the hands. For example, U.S. Pat. No. 6,540,103 issued to Silvers illustrates a multiple-compartment bin that would be located on the floor of, for example, a home nursery or day care facility that contains new diapers, baby wipes, and a sealed receptacle for disposing of the used diapers. The wipes are stacked in a sealed compartment to keep them clean and slow down the evaporation of the cleaning solution contained in the wipes. A sanitation kit for placement on a table or counter is disclosed in U.S. Pat. No. 5,753,246 issued to Peters consisting of a container for a stack of germicidal towelettes hermetically sealed in envelopes, and a disposal bin attached to the towelette container. Similarly, U.S. Pat. No. 6,702,147 issued to Ashford shows a “Bedside Butler” unit for a hotel or home night table that constitutes a box with two containers—one container with a sealed flap for dispensing antimicrobial wipes, and a second container for disposing of the used wipes. However, none of these dispenser units is portable. Likewise, in none of them is a wet wipe towelette visibly available in order to encourage a person to wash his hands.

A door sanitation kit similar to Arians is disclosed in U.S. Pat. No. 6,508,383 issued to Lidahl et al. except that a wet towel is dispensed for covering the hand prior to grabbing the handle to open a public bathroom door. U.S. Pat. No. 6,691,897 features a pole stand for use in a public area to which is attached a wet wipe dispenser, an antimicrobial soap dispenser, and spray bottle, and a waste basket. The patent discloses that this apparatus can be used for dispensing free cleaning and sanitizing supplies to the public, and that an advertising display can be added to provide a benefit to the merchant who makes this sanitation station available to its customers. Nevertheless, such an arrangement looks relatively rickety and is subject to falling over or being accidentally tipped over. Moreover, the wet wipe dispenser, hand soap dispenser, spray bottle, and pole provide a number of surfaces that need to be kept clean so as not to detract from the sanitary appearance of such a “sanitizing stand.” In a similar vein, the open waste basket is subject to overflowing and will show any other messy garbage that is dumped in it by a customer.

Therefore, there is a need for methods of making hand wipes readily available inside restaurants, cafeterias, diaper changing stations, ballparks, casinos, petting zoos, kitchens, restrooms, and any other public or work areas where good hand hygiene is important. The opportunity to grab a disposable hand wipe to clean one's hands is convenient and may even remind the person to clean his or her hands. Good hand hygiene does not take much time or effort when it is convenient, and it offers great benefits in terms of preventing illness and the spread of infectious diseases.

### SUMMARY

The present invention provides systems, methods, and apparatus for integrated cross corporate branding using a hand wipe product. The invention includes advertising by producing a plurality of high quality, individually packaged, disposable hand wipes packaged in a wrapper, the wrapper including an indicia of a third-party and an indication of an online source for additional hand wipes, wherein the high quality of the hand wipes is such that the third party perceives that an association of the third party with the hand wipes reflects positively on the third party; distributing the plurality of hand wipes to target customers of the third party without charge to the target customers; and selling additional hand wipes to the target customers via the online source. Other features and aspects of the present invention will become more fully apparent from the following detailed description, the appended claims, and the accompanying drawings.

### BRIEF DESCRIPTION OF THE DRAWINGS

FIG. 1 is a flowchart that depicts an example method according to some aspects of the present invention.

### DETAILED DESCRIPTION

Advertising a corporate logo, company slogan, or business brand is a primary tenet of capitalistic society. The average person is bombarded with thousands of promotions each day, from a wide variety of media . . . television, movies, radio, billboards, magazines, direct mail, clothing, e-mail, online banners, and word of mouth, to name a few.

As brains are attacked thousands of times per day with messages, bodies are attacked as many times per second . . . with microbes. In defense, antimicrobial soaps, solutions, and wipes have become accepted artillery in the fight against germs. And considering that up to 80% of infections are spread through hand contact, antibacterial hand wipes are one of the most important first steps in killing the microorganisms that make us sick and diseased.

Corporations use advertising because it works. Consumers use hand wipes because they work. This patent application intends to merge the two industries, corporate advertising and cleaning hands, with a unique and synergistically rewarding process. This patent application intends to capture the highest quality product along with an economically efficacious process of “antibacterial ‘viral’ marketing.”

Firstly, this hand wipe product brings the highest standard of style, softness, strength, smell, and solution to individually wrapped moist towelettes.

In addition to the hand wipe product having a unique combination of material and content, much better than existing hand wipes, the packaging is revolutionary. With full-color, crisp printed images on both sides of the wipe package, another company's logo, slogan, brand, promotion, or other business information can be prominently displayed on the wipe. This Integrated Cross-Corporate Branding (ICCB) ability (the wipe with the company) allows other businesses to provide a novel and superior method of hand cleaning and disinfecting to their clients and customers. Moreover, it affords the Participating Company, Group or Individual (PCGI) the opportunity of utilizing a superior hand wipe to their advantage, as a high-end, low-cost giveaway (or sellable) promotional item which will help increase consumer awareness, brand appreciation, and sales for that company.

The hand wipe manufacturing processes is highly advanced for printing, etching, or engraving logos, slogans, designs or messages, to ensure that they do not fade or degrade. Full-color graphics and four, five, or even six-color process printing is used for effervescent colors, tones, or even metallic shadings. As the perceived image of the PCGI is associated with the quality of the image on, and first impression of, the hand wipe, the product must appear to be produced to the highest of standards. The hand wipe substrate and cloth is also of the highest quality of strength, softness, scent, stamina, and sanitization, using the best options in the industry.

One example of an embodiment of a high quality hand wipe suitable for use with the present invention is a disposable germicidal towelette packaged for single use. For example, a liquid impermeable package containing a folded anti-septic towelette treated with chlorhexidine gluconate solution, aloe vera, vitamin E, and natural extracts for use as a moisturizing, disinfectant hand-wipe may be employed. The towelette may also contain aloe vera extract formulation, vitamin E extract formulation, with several blends of ingredients which are impregnated into the towelette. The towelette may be hermetically sealed in a tear-open packet. CAS #'s used for aroma extracts are as follows:

| | |
|---|---|
| Banana Extract | 89957-82-4 |
| Propylene Glycol | 55-55-6 |
| Glycerin | 56-81-5 |
| Aloe Barbadensis Extract | 8001-97-6 |
| Tocopherol Acetate | 7695-91-2 |
| DMDMH | 6440-58-0 |
| Mehtylparaben | 99-76-3 |
| Germal 2 | 78491-02-8 |
| Chlorhexidine Gluconate | 18472-51-1 |
| Water | 7732-18-5 |

The packaged germicidal towelette includes a disposable, absorbent, sheet material suitable in size and strength for single-use wiping of the hands of a user and impregnated with a chlorhexidine gluconate solution. Chlorhexidine gluconate solution is chosen as a broad-spectrum disinfecting agent, imparted to the sheet material to create an effective anti-bacterial towelette for use against commonly encountered bacteria. A suitable size of the towelette is approximately 4 inches by 6 inches, which is large enough to provide adequate surface area for wiping the hands; however, a range of sizes extending to a larger “paper-towel sized” wipe is an addition embodiment. A suitable non-woven micro-fiber material (with strength and texture) allows for the towelette's effectiveness to be fully realized.

To counter the drying effects on the skin, skin moisturizers consisting of the group of aloe vera, Vitamin E, and natural extracts are further impregnated in the sheet material.

However, because one of the intended purposes of the towelette is directed towards use of the towelette immediately before eating to prevent the ingestion of bacteria from hand-borne germs, the amount of aloe vera, Vitamin E, and additional extracts need only be sufficient to counter the drying effect of the chlorhexidine gluconate solution and provide sufficient aroma. For example, an excessive amount of Vitamin E may be undesirable as it may interfere with enjoyment of the meal by imparting an oily film or undesirable aroma inconsistent with the food about to be eaten.

For convenience of the consumer, the towelette is provided in a hermetically sealed envelope. The hermetically sealed envelope is preferably a tear-open, rectangular packet, of pocket-sized dimensions, approximately 3 inches by 3.5 inches (or smaller or larger). A foil based or plasticized material or combination there of may be suitable to provide a liquid and air impermeable packet. Packaging may also include a combination of foil, plastic, and or paper in part or in whole. Before sealing the envelope, the sheet material is multiply folded into a generally rectangular folded form and hermetically sealed in the folded form. A textured towelette with dimensions of approximately 4 by 6 inches is able to be folded by three fold lines into a rectangular folded form measuring approximately 2.5 inches by 3.5 inches which is closely received by the envelope.

Such a packaged towelette may be effectively distributed to promote good hygiene habits in a variety of modalities. This product is intended to be of outstanding high quality, such that it may be used as or in retail applications, corporate branding applications, product promotions, giveaways, incentives and or as handouts.

It is to be understood that the present invention is not limited to the sole embodiment described above, but encompasses any and all embodiments within the scope of the appended claims.

Currently, commercially available individually packaged hand wipes are not high quality to the degree that neither (1) a business would perceive that being associated with such hand wipes reflects positively on their business, nor (2) an individual using the currently available, conventional hand wipes would be impressed with the high quality and associate high quality with the brand on the package.

The intent is to provide means for product advertising on the packaging of a hand wipe product. The PCGI seeking advertising, promotion, or sales through this method, in effect, contracts the wipe company, the Integrated Cross-Corporate Branding (ICCB) company, and pays for this service, enabling the aforementioned benefits in addition to affording PCGI the opportunity to give away prizes for associated contests/sweepstakes/challenges associated with this program.

Consumer awareness is enhanced by recognition of the hand wipe and also of the corporate brand. Additional methods of advertising will reinforce this association. Furthermore, the option exists for corporate contests/sweepstakes/challenges, in which the company's prizes are given away to consumers who receive the hand wipe. There are also “no purchase necessary” opportunities, which will be made available through this process.

The benefits to a PCGI by using the ICCB process can be tremendous. This hand wipe product can be economically distributed to current consumers and potential patrons of a participating company. Hand wipes, especially individually-wrapped wipes carried around in pockets and stored in various locations (glove compartments, lunchboxes, bathrooms, backpacks, etc.), will constantly promote brand awareness and a pleasant hand cleaning experience to a PCGI's current and potential customers. Because of the giveaway nature of this product, corporations can literally disperse them by the thousands, millions, or even billions. An individual wipe, with both the ICCB trademarked name/image and the specific PCGI information presented on the front and/or back of the wipe package, exclusively or in combination, can be given or sold to every single consumer during every conceivable form of business transaction.

The following are a few examples of potential embodiments of this process. A single cross-corporate branded wipe can be made available to every person who eats at a restaurant, orders at a drive-thru, purchases an item in person, meets with vendors at a trade show, visits a place of business (with or without an official transaction), has an appointment with a doctor, receives a gift from a company, accepts service from a person or corporation, or orders an item online, regardless of content or cost. Corporations can offer these individual wipes either at no cost or provide them as a retail item in either individual, small-packaged, or big-bulk quantities.

Since the hand wipes are of the highest quality and superior to existing wipes currently found in the marketplace, the PCGI may also choose to give away an individual wipes AND additionally provide current consumers or potential patrons with a larger volume of wipes at a predetermined retail price point. One example of embodiment for this scenario is the fast-food and drive-thru industries. For instance, McDonald's may choose to include one or two hand wipes in every Happy Meal or drive-thru purchase. These individual wipes would be complimentary, such as a napkin, or ketchup, or a packet of sugar. However, because of the superlative nature of this particular hand wipes, recipients are likely to request additional product; furthermore, they will be willing to purchase these additional hand wipes because of the quality of the scent, stamina, softness, sanitization, substrate, and solution, etc. Because of the quality of the product, they will be purchasing additional quantities of the PCGI and ICCB brands, and potentially distributing these branded wipes to additional potential consumers. A variety of other embodiments are also available.

All wipes can be distributed with any combination of the following:

1. Wipes with the ICCB company name and trademarks.
2. Wipes with cross-corporate branding, containing both ICCB name/trademark and the PCGI information of another. Both companies' information can include, but are not limited to, logos, slogans, advertisements, images, websites, promotions, and other business information.
3. Wipes displaying only the PCGI information, regardless of whether or not it also contains the specific (ICCB) wipe brand name and trademark. In this case, the hand wipes continue to be superlative in the marketplace, and are manufactured and distributed by the ICCB company, either directly or by third-party outsourcing, but the image will be that of the participating corporate or PCGI “sponsor.” The consumer may still be directed to the ICCB website for the online promotion aspect of this concept, or this may be coordinated directly by the PCGI.

In the following examples, specific corporate names can be substituted with similar companies or PCGI applications. These are only examples and hand wipes can be provided in either a non-compete exclusivity manner or via competitive category nature.

The following are additional sample embodiments. These are only examples and other embodiments are also possible. Individual wipes can be handed to every person who orders at Starbucks, Dunkin Donuts, McDonald's, Burger King, Wendy's, and other restaurants or fast-food eateries. Wipes can be placed in cars after going to Jiffy Lube or Midas, or other automotive businesses. Wipes can be placed in the glove compartment of every car sold by Porsche, Mercedes, or Ford, and the like. Individual wipes can be given away at the food court at Costco (or Sam's Club, or BJ's Wholesale, etc.) and then sold in bags or bulk in the retail section of Costco or other retail club stores. Wipes can be given away at Subway, one in each bag, and then sold in Wal-mart (or Target, or K-Mart, etc.) in a retail application. Wipes can be given away at movie theaters, subways, buffets, health clubs, and other retail or service-oriented businesses. Wipes can be added to packages or mailings of any package from QVC, HSN, Land's End, or Staples (and the like), then sold online or by phone, or by, for example, Guardian insurance company (as a promotion of good health and the directed to an online ordering system), or by any similar companies. They can be physically attached to products (i.e. glued to a Poland Spring water bottle), added to products (i.e. put in a box of Cherrios), offered as an option (placed on a pillow in hotels), or enforced and made mandatory (i.e. at Stop & Shop or Publix grocery stores before touching shopping cart handles). They can be given out with every food or drink purchase at every sporting event (Mets, Giants, etc.) or local activity (picnics, parades, concerts, etc.), to every passenger in every seat on every commercial airline flight or other mode of transportation, on every lunch tray at every school, and to every patient at every hospital. Each Participating Company, Group, or Individual (PCGI) wipe will incorporate the Integrated Cross-Corporate Branding (ICCB) process with the appropriate information of both the branding company as well as the PCGI information (i.e. team, airline, academy, and institution, etc.)

Regardless of how the hand wipes are distributed, they are then potentially re-distributed to friends, family, business contacts, and strangers from the initial recipient. Hand wipes are always in demand and, especially because of the superior graphics, smell, texture, softness, texture, and solution, and unique PCGI/ICCB text/images, they will most likely be viewed as vastly superior and shared with others, thereby promoting the branding and image of the PCGI. If one person is using a wipe, they are very likely to give another to somebody else. This process, branding a PCGI image on a ICCB wipe, provides additional advertisements that would never be realized without this product or process. The company, in effect, receives multiple exposure via single item giveaways or sales. ICCB allows for antibacterial viral marketing of the PCGI. Moreover, recipients are encouraged to continue the “relationship” with both PCGI and ICCB due to the incentives offered via contests, sweepstakes, and challenges.

Additionally, multiple PCGIs can promote each other. For example, an airline recipient becomes aware of a fast-food company's offers by visiting the ICCB website, which promotes links to each and every participant's special offers. A fast-food-branded hand wipe can be given away by airlines. An airline-branded wipe can be made available at the concession stands of movie theaters. A movie-branded wipe can be presented at fast-food restaurants. This synergistic cycle can be made available in a countless variety of other embodiments.

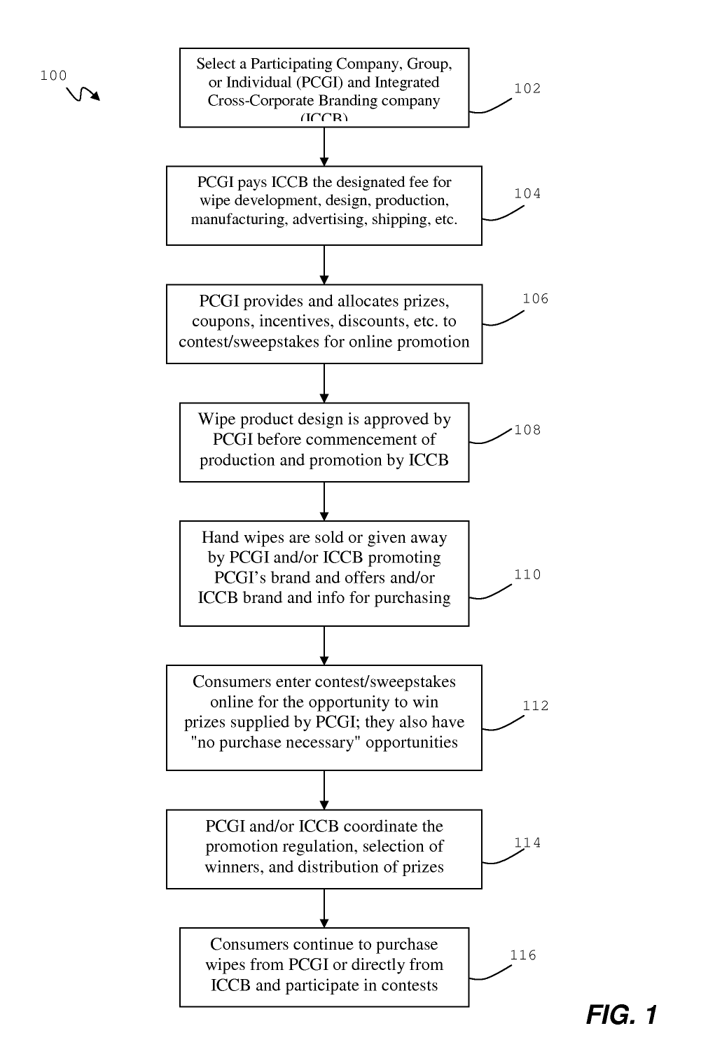

An example embodiment of the process 100 of the present invention is summarized in FIG. 1. To begin the process 100, in step 102, the Participating Company, Group, or Individual (PCGI) will be selected by the Integrated Cross-Corporate Branding company (ICCB) for inclusion in this system. In step 104, terms are contracted and PCGI pays ICCB the designated fees for wipe development, design, production, manufacturing, advertising, shipping, etc. ICCB acts as the manufacturer and/or supplier of the hand wipe products for each PCGI partaker. In step 106, though participation in the additional incentives and promotions are optional, if warranted, PCGI provides and allocates prizes, coupons, incentives, discounts, etc. to contest/sweepstakes for online or in hand promotion of their brand. In step 108, final wipe product design is submitted or reviewed, then approved by PCGI before commencement of production and promotion by ICCB. In step 110, hand wipes are sold, given away, or otherwise distributed by PCGI and/or ICCB promoting PCGI's brand and promotional offers and incentives, and/or ICCB brand and info for additional purchase. In step 112, consumers and/or recipients enter contest/sweepstakes online for the opportunity to win prizes supplied by PCGI or ICCB or another PCGI involved in the process; they also have “no purchase necessary” opportunities. In step 114, PCGI and/or ICCB coordinate the promotion regulation, selection of winners, and distribution of prizes. In step 116, consumers continue to purchase wipes from PCGI and/or directly from ICCB and participate in existing and future contests or promotions.

### In Summary:

PCGI pay for the rights to advertise and promote on a ICCB hand wipe package and/or product.
PCGI receives their logo, slogans, branding, or other business information on the hand wipe package and/or product.
PCGI can also choose to give away prizes to enhance consumer awareness on the hand wipe package and/or product, and joint venture with other PCGIs involved with the ICCB process.
The content/sweepstakes or prize giveaways will be handled online on the ICCB hand wipe's website and/or the individual PCGI website, or at the location of a specific individual event.

For example, a movie production company (i.e. MGM) (or movie theatre chain—i.e. Lowes) (the acting PCGI in this instance) agrees to purchase advertising space on the hand wipe package, designed and manufactured by ICCB. The advertising space consists of the corporate logo, upcoming movie, promotion, incentive, and/or slogan as defined, submitted, reviewed, or accepted by the film company. The film PCGI provides, in this example, 1,000 free large bucket of popcorn coupons which can be received by consumers by entering a contest/sweepstakes online through the ICCB and/or PCGI website. Or, in another example, the movie-goers can win a free movie(s), a trip to a movie premiere, an entire movie theater to host a movie party, an opportunity to watch a movie with the star (i.e. Matt Damon), and the like. These wipes can be sold or given away by the PCGI directly, with the assistance of ICCB, and/or by a third-party, such as the inclusion of these wipes with every food or drink item purchased from the theater concession stand. This third-party scenario may or may not include financial participation and/or compensation from the third-party (i.e. Hershey's or Mars candy).
1. PCGI seeking advertising pays ICCB the designated fee for production, advertising, manufacturing, expenses, wipes, shipping costs, etc.
2. PCGI provides a set amount of prizes, coupons, incentives, discounts, etc. to supply for the contest/sweepstakes.
3. ICCB prints PCGI information on the wipes, coordinates the advertisements/contest/sweepstakes on the website, and hyperlinks to the participating company and information on the ICCB and/or website.
4. Hand wipe product design is approved by PCGI and enters production.
5. The hand wipes are sold or given away through PCGI, ICCB, and a variety of other retail and giveaway applications, including the purchase of other non-related products.
6. Consumers enter contest/sweepstakes online for the opportunity to win the prizes supplied by the advertising company and some consumers win prizes through “no purchase necessary” opportunities. Instant winners in any of the above scenarios (i.e. upon receipt of a specially marked or targeted hand wipe) may also be awarded prizes immediately and/or at a future date.

This process is simultaneously repeated with an unlimited number of PCGIs, either with category exclusivity or with competing organizations. Advertising opportunities on a hand wipe product will involve the integrated cross-corporate branding, advertising, and giveaway process, with the outcome of gaining respective consumer awareness, purchase, and favor for moist towelette packaging, promotion, and distribution.

Hand wipe products involving the packaging as the opportunity for a multitude of other companies to advertise have never been available, especially with the added benefit of a single ICCB coordinating multiple and synergistic PCGI promotions. The benefits of one product with multiple product advertising benefits is an integrated cross-corporate branding, advertising, and giveaway/sweepstakes process that promotes consumer awareness to purchase and/or to participate with company programs and incentives via online or in person processes. This is a new use in this industry. It is the unique ability and process of combining the hand wipe and corporate branding/marketing industries that allows companies the ability to promote to a vast audience with a revolutionary method.

The actual hand wipe product used, in part, as a corporate branding opportunity to promote a company for advertising purposes must be of the utmost quality, considering that the image and brand of one directly and indirectly reflects the image and brand of the other. PCGI logo/text/info would be printed on one or both sides of hand wipe packaging used to brand the company in a unique way via ICCB offers and online promotions. ICCB information may or may not be visible to the consumer. Example of intended use: a customer is given or purchases a corporate branded hand wipe and is motivated to go online to participate in a contest/sweepstakes promotion, in order to win prizes, receive discounts, incentives, etc. This process encourages brand loyalty and repeat business for both PCGI and ICCB.

The foregoing description discloses only particular embodiments of the invention; modifications of the above disclosed methods and apparatus which fall within the scope of the invention will be readily apparent to those of ordinary skill in the art. For example, while the steps of the methods described above are presented in a particular order, many alternative orders are possible and many additional sub-steps, super-steps, and/or alternative steps may be used.

Accordingly, while the present invention has been disclosed in connection with specific embodiments thereof, it should be understood that other embodiments may fall within the spirit and scope of the invention, as defined by the following claims.

1. An advertising method comprising:
producing a plurality of high quality, individually packaged, disposable hand wipes packaged in a wrapper, the wrapper including an indicia of a third-party and an indication of an online source for additional hand wipes, wherein the high quality of the hand wipes is such that the third party perceives that an association of the third party with the hand wipes reflects positively on the third party;
distributing the plurality of hand wipes to target customers of the third party without charge to the target customers; and
selling additional hand wipes to the target customers via the online source.
